(19) United States
(12) Patent Application Publication
(10) Pub. No.: US 2019/0249706 A1
(43) Pub. Date: Aug. 15, 2019

(54) Threaded Fastener Load Monitoring

(71) Applicants: Kristoffer Albert Hess, Cambridge (CA); Markus Jaan Hess, Thornhill (CA); John Carlos Sousa, Mono (CA)

(72) Inventors: Kristoffer Albert Hess, Cambridge (CA); Markus Jaan Hess, Thornhill (CA); John Carlos Sousa, Mono (CA)

(21) Appl. No.: 16/341,943

(22) PCT Filed: Oct. 19, 2017
(86) PCT No.: PCT/IB2017/056519

§ 371 Date: Apr. 15, 2019

(30) Foreign Application Priority Data
Oct. 19, 2016 (CA) 2945764

(51) Int. Cl. F16B 31/02; G01K 7/22; G01L 5/00

(52) U.S. Cl. CPC F16B 31/025; B60B 3/16; G01L 5/00; G01K 7/22

(57) ABSTRACT

The threaded fastener has a head end, a far end and a hollow core between the head end and the far end. A reference rod is mounted inside the hollow core. The reference rod has an anchor end attached to the far end of the threaded fastener and a free end extending in the head end. A flexible contact element is attached to the free end of the reference rod and is movable in the head end of the threaded fastener along a displacement path upon elongation and relaxation of the threaded fastener. Switch elements are mounted in the head end of the threaded fastener along the aforesaid displacement path of the flexible contact element. The switch elements are making calibrated contact with the flexible contact element upon a movement of the flexible contact element during a movement of the flexible contact element along its displacement path.

### TECHNICAL FIELD

This disclosure pertains to strain monitoring of bolts and rods and more particularly it pertains to a load monitoring system for incorporation in wheel studs of road vehicles.

### BACKGROUND

Vehicle wheel rims are commonly mounted to a hub by lug nuts fastened down on an equal number of wheel studs. Failure of wheel studs may occur when lug nuts come loose or if the material of the wheel and vehicle components gripped by the wheel studs and lug nuts diminish and disintegrate. Failure of wheel studs and runaway wheels in road vehicles causes many accidents every year. According to provincial records, 70% of wheel stud failures are due to wheel studs losing clamping force. It would be a benefit to the vehicle operator and to public safety if the operator could be alerted to these conditions while the vehicle was in operation.

Wheels detach from transport trucks and trailers at a significant rate. According to 643 reported incidents in the US that were analyzed between 2000 and 2003, the reasons that wheels become detached include loose wheel fasteners (clamping force of nuts to hub) (65%), failed bearings (26%) and other causes such as axle and/or suspension structural failures (9%).

Despite numerous innovations in the field, this type of roadway accident is still very high. The industry continues to use torque for defining the safety range of lug nut tightening rather than wheel stud tension, also referred to herein as clamping force or strain. However, torque is a very poor indicator of clamping force of fasteners. The condition of the surfaces of the threads, nut, and wheels can change the relationship of torque to clamping force significantly. If there is rust or paint on the wheel surface that changes in thickness during use, the clamping force will be reduced. A change of 0.001″ thickness will reduce clamping force by approximately 15%. Furthermore, torque is largely taken up by friction and only 10% is taken up by tension. Therefore, there is not a good correlation of torque to wheel stud tension/clamping force. Wheel stud tension may vary for a given torque value depending on factors such as bolt age, condition (for example deterioration and rust) and lubrication.

The most popular system in use for detecting the loosening of a wheel nut is a colored pointer that mounts to a wheel nut and is set in a specific orientation. When all pointers are aligned radially or circumferentially relative to the wheel for example, a nut that has rotated out of position can be identified at a glance. This type of pointer is described in the following publications:
U.S. Pat. No. 6,158,933, issued to O. Nicholson, on Dec. 12, 2000; and
U.S. Pat. No. 6,398,312, issued to M. Marczynski et al., on Jun. 4, 2002;
U.S. Pat. No. 8,152,426, issued to M. Marczymski on Apr. 2, 2012;
GB 2,508,152, published by A. A. Petrus de Groot, on May 28, 2014;
GB 2,536,294 issued to R. E. Woods on Sep. 14, 2016.

Another relevant technology found in the prior art includes a circuit, a sensor and a transmitter mounted in a wheel nut. A signal is transmitted to the vehicle alarm system when the wheel nut is unscrewed or removed. This system is described in:
U.S. Pat. No. 5,552,759 issued to D. Stoyka on Sep. 3, 1996, and
WO 2016/042513 A1 published by C. E. Lopes on Mar. 24, 2016.

Other devices for detecting a loose lug nut include deformable washers mounted under a nut to be monitored. These washers give a visual or an electronic signal when a nut has been unscrewed or removed. Some of these devices are described in the following documents:
U.S. Pat. No. 3,589,234 issued to J. V. H. Trigg on Jun. 29, 1971;
U.S. Pat. No. 4,636,120 issued to T. A. Brandsberg et al., on Jan. 13, 1987;
U.S. Pat. No. 8,872,668 issued to G. G. Schnare on Oct. 28, 2014.

Other visual indicators of loose bolts are described in the publications listed below. In these documents, there are described different visual indicia, changing color or position, on the head of bolts, to indicate a degree of rotation of the bolts.
U.S. Pat. No. 3,248,923 issued to RH. Blakeley on May 3, 1966;
GB Patent 1,316,899 published by Gyrfalcon Inc., on May 16, 1973
U.S. Pat. No. 3,799,108 issued to J. E. Mosow on Mar. 26, 1974;
U.S. Pat. No. 3,850,133 issued to RC. Johnson on Nov. 26, 1974;
CA Appl. 2,069,319 published by B. Walton on May 28, 1991;
U.S. Pat. No. 5,584,627 issued to S. Ceney et al., on Dec. 17, 1996; and
WO 2009/049060 published by C. H. Popenoe on Apr. 6, 2009.

In an electronic sensor category of loose bolt indicators, we can find technologies using various instruments, such as described herein below:

U.S. Pat. No. 2,600,029 issued to A. R. Stone on Jun. 10, 1952. This document describes a bolt with a strain gauge mounted along the central axis of the bolt. A strain on a wire at the center of the bolt changes the resistivity of that wire, and by conversion of amperage to pounds of force, the resistance of the wire indicates a degree of strain of the bolt.

U.S. Pat. No. 3,969,713 issued to R Bossier, Jr., on Jul. 13, 1976. This document describes a series of contacts mounted on the head of a bolt to measure head deformation corresponding to a desired pre-load of a bolt or to a no-load condition.

US Pat. RE. 30,183 issued to C. H. Popenoe on Jan. 8, 1980. This patent describes a passive chip mounted in the head of a bolt. A reference pin at the center of the bolt indicates the relative elongation of the bolt, and applies more or less pressure on the chip. A corresponding change in inductance or capacitance of the elements of the chip are interrogated by a remote electronic meter to detect the condition of the bolt.

U.S. Pat. No. 5,291,789 issued to B. Walton on Mar. 8, 1994. This document discloses an instrument to measure, by electrical contact, the relative elongation between a bolt and a stem mounted at the center of the bolt. A pair of set screws and circuit contacts on the head of the stem are calibrated to indicate two different stress levels in the body of the bolt.

U.S. Pat. No. 7,412,898 issued to J. D. Smith et al. on Aug. 19, 2008. This document also discloses a passive chip mounted in the head of a bolt. The chip includes a radio-frequency identification transponder. A stem at the center of the bolt indicates the relative elongation of the bolt and activates an on-off contact on the chip to indicate a stress condition of the bolt. The chip is interrogated periodically by preventive maintenance personnel, for example, using a portable radiofrequency (RF) transmitter/receiver.

In yet another document found in the prior art, a bolt has a central cavity filled with a fluid and a pressure sensor mounted in communication with the hollow core. This technology is described in:

U.S. Pat. No. 7,994,901 issued to C. S. Malis et al., on Aug. 9, 2011. A piezoelectric pressure sensor is mounted in the head of the bolt. This sensor measures the pressure in the fluid of the cavity and translates it to strain in the bolt. An RF transmitter is also mounted in the head of the bolt and transmits the condition of the bolt to a vehicle warning system for example. One embodiment described in this document uses a piezoelectric sensor to generate power from the movement of the wheel on which the bolt is mounted to energize the RF transmitter.

Despite the advances in this field, there remains a need for a system capable of measuring a change in tension in a threaded fastener, or more specifically a wheel stud, and bearing condition and to warn a vehicle operator of a dangerous condition of that wheel stud.

### SUMMARY

In the present disclosure, there is described a threaded fastener load monitoring system that is enclosed inside a threaded fastener and detects precarious conditions on that threaded fastener. These conditions can be readily transmitted to the operator of the vehicle to avoid a hazardous situation.

In a first aspect of the present invention, there is provided a threaded fastener load monitoring system comprising a threaded fastener having a head end, a far end and a hollow core, between said head end and said far end, a reference rod mounted in said hollow core, said reference rod comprising an anchor end held to said far end of said threaded fastener and a free end extending to said head end, a flexible contact element mounted to said free end of said reference rod, said flexible contact element being movable to said head end of said threaded fastener along a displacement path upon elongation and relaxation of said threaded fastener, and one or more switch elements mounted to said head end of said threaded fastener at a proximity of said flexible contact element and along said displacement path of said flexible contact element.

In another aspect of the present invention, there is provided a threaded fastener load monitoring system comprising a threaded fastener comprising a head end, a far end and a hollow core between said head end and said far end, a reference rod mounted in said hollow core, said reference rod comprising an anchor end attached to said far end and a free end extending to said head end, a flexible contact element mounted to said free end of said reference rod, said flexible contact element being movable in said head end upon elongation and relaxation of said threaded fastener, first and second switch elements mounted in said head end of said threaded fastener at a proximity of said flexible contact element, said first switch element being positioned to make contact with said flexible contact element when said flexible contact element is in a first position and said first and second switch elements being positioned to make contact with said flexible contact element when said flexible contact element is in a second position, and an electronic circuit interpreting conditions of said first and second switch elements.

In another aspect of the present invention, there is provided a road vehicle having a wheel rotor assembly comprising a wheel rotor, a wheel stud mounted to said wheel rotor and a wheel stud load monitoring system mounted to said wheel stud, said wheel stud load monitoring system comprising a stud comprising a head end, a far end and a hollow core, a reference rod mounted in said hollow core, said reference rod comprising an anchor end held to said far end, a free end extending to said head end, a flexible contact element mounted to said free end of said reference rod, said flexible contact element being movable in said head end along a displacement path extending between a first position and a second position, upon elongation and relaxation of said wheel-stud, at least one switch element mounted in said head end at a proximity of said flexible contact element and along said displacement path of said flexible contact element, said switch element making calibrated contact with said flexible contact element upon a movement of said flexible contact element along said displacement path and an electronic circuit mounted in said wheel hub interpreting conditions of said switch element.

In another aspect of the present invention, there is provided a method for assembling a load monitoring system comprising inserting a rod with an attached flexible contact element in a hollow core of a threaded fastener, said threaded fastener having a head, a far end, a hollow core extending from said far end to said head and a larger cavity in said head, applying a first tension to said threaded fastener, mounting a cap on said head of threaded fastener, placing a first switch element through a first transverse hole in said cap so that said first switch element abuts said flexible contact element, fixing said first switch element to said cap with an adhesive, applying a second tension to said threaded fastener, placing a second switch element through a second transverse hole in said cap so that said second switch element abuts said flexible contact element, and fixing said second switch element to said cap with said adhesive.

A more complete understanding of the wheel-stud load measuring system can be obtained by reference to the following detailed description of the preferred embodiments thereof in connection with the attached drawings.

### BRIEF DESCRIPTION OF THE DRAWINGS

Two preferred embodiments of the threaded fastener load monitoring system are described herein with the aid of the accompanying drawings, in which like numerals denote like parts throughout the several views.

FIG. 1 is a perspective view, for reference purposes, of a typical wheel rotor assembly of a vehicle having a disk brake assembly.

FIG. 2 is a front view of the wheel rotor in FIG. 1.

FIG. 3 is a perspective view, for reference purposes, of a typical wheel rotor assembly of a vehicle having a drum-type brake shoe assembly.

FIG. 4 is a cross-section view and detail view of a wheel stud having a first preferred embodiment of a load monitoring system mounted therein.

FIG. 5 is a perspective cross-section view of the embodiment of the load monitoring system illustrated in FIG. 4.

FIG. 6 is a perspective cross-section view of another embodiment of the load monitoring system.

FIG. 7 is a perspective view of the embodiment of the load monitoring system illustrated in FIG. 6.

FIGS. 8, 9 and 10 are enlarged cross-section views of the contact end of the load monitoring system showing the contact disk thereof in three different configurations.

FIG. 11 is a schematic diagram of a preferred embodiment of a signalling system for the load monitoring system.

The drawings presented herein are presented for convenience to explain the functions of the elements included in the preferred embodiments of the threaded fastener load monitoring system. Elements and details that are obvious to the person skilled in the art may not have been illustrated. Conceptual sketches have been used to illustrate elements that would be readily understood in the light of the present disclosure. Some details have been exaggerated for clarity. These drawings are not fabrication drawings and should not be scaled.

### DETAILED DESCRIPTION

The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

The following description refers to a wheel stud load monitoring system. It will be understood by those skilled in the art that the disclosure provided may be used to monitor load in other threaded fasteners.

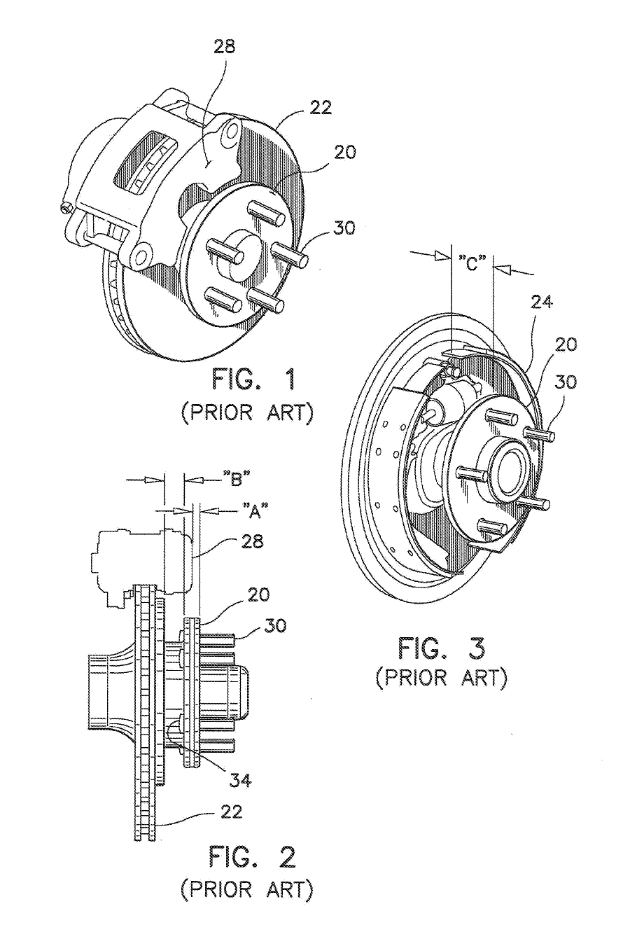

The drawings of FIGS. 1, 2 and 3, have been included to confirm the practicality of the wheel stud load measurement system described herein and to improve on the enablement of the present disclosure.

Despite what is seen by the casual onlooker, there is generous space to mount an instrument within close proximity to the head of a wheel-stud. In the following description, wheel rotor may be used interchangeably with wheel hub. There is generous space between a wheel rotor 20 and a brake disc 22 or a brake shoe 24 of a vehicle's wheel assembly. In a disc type brake assembly, sufficient clearance “A” in FIG. 2 is provided so that a wheel rim (not shown) mounted to the face of the rotor 20 will not rub against the caliper assembly 28. Because the brake caliper assembly 28 has a substantial volume, a generous space “B” is available between the rotor 20 and the disc 22 of the brake assembly.

This generous space is larger in a drum-type braking system, as can be appreciated by the dimension “C” in FIG. 3. The components of this type of braking system (only partly shown) are mounted close to the centerline and outside diameter of the brake shoes 24, leaving an empty space behind the wheel rotor 20. This empty volume generally has a diameter that is larger than the bolt circle of the studs 30 on that rotor 20.

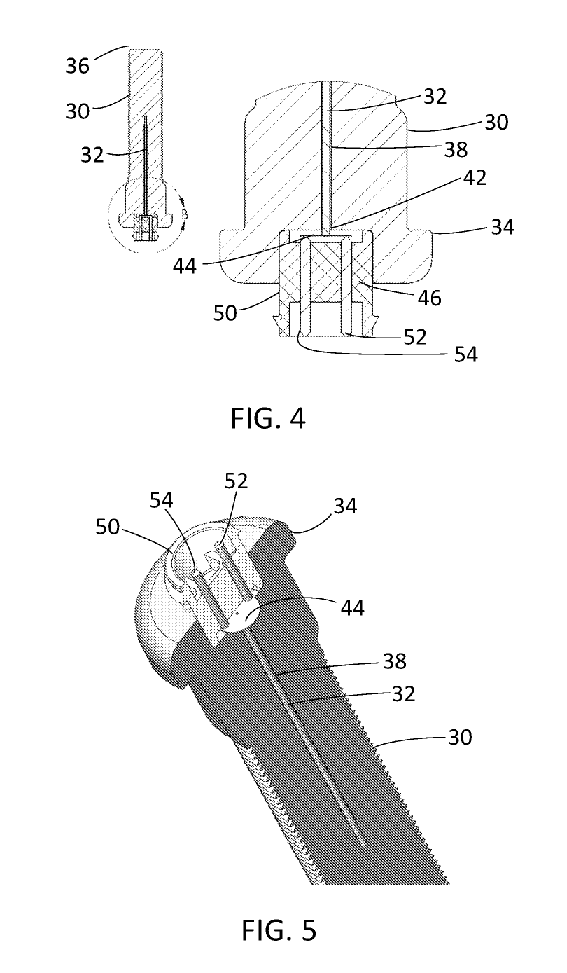

Preferred embodiments of a load monitoring system are presented in FIGS. 4 to 11. Referring firstly to FIG. 4, the wheel stud 30 in this preferred embodiment has a central axial hole; a hollow core 32 therein. The hollow core 32 extends from the head 34 of the stud 30 to the far end 36 of the stud 30. In this central axial hollow core 32, there is mounted a reference rod 38. An anchor end 40 of the reference rod 38 is affixed to the far end 36 of the stud 30, for example with adhesive or by press-fit engagement of the anchor end 40 of the reference rod 38. In use, the free end 42 of the reference rod 38 moves along the hollow core 32 relative to the head 34 of the stud 30 as the stud stretches under load. The free end 42 of the reference rod 38 moves along the axis of the wheel stud 30 relative to the head 34 of the stud along a displacement that corresponds to the total elongation of the wheel stud 30 under load. The thermal coefficient of the stud 30 and reference rod 38 are similar, so that the stud 30 and rod 38 expand at the same rate throughout temperature changes.

The free end 42 of the reference rod 38 has a flexible contact element, preferably a flexible disk spring 44 mounted perpendicularly thereto. The flexible contact element allows the reference rod 38 to be of small diameter, thus allowing a minimal reduction in strength of the stud 30. The flexible disk spring 44 is preferably a gold-plated disk spring, and it may be micro-welded or attached by adhesive to the free end 42 of the reference rod 38. As mentioned, the associated movement of the free end 42 of the reference rod 38 and of the disk spring 44 is indicative of the elongation of the stud 30 under load.

The stud head 34 has a larger cavity 46 therein relative to the hollow core 32. In this larger cavity 46, there is mounted an insulative cap 50 containing two preferably gold-plated metal pins 52, 54 extending parallel with the axis of the reference rod 38. The pins 52, 54 are spaced apart a distance that is less than the diameter of the disk spring 44 so that contact can be made between the disk spring 44 and both pins 52, 54. The pins 52, 54 are electrically insulated from each other by the insulative cap 50. The cap 50 is preferably made of plastic and is mounted to the head end 34 of the stud 30. By this arrangement, a switch is effectively closed upon contact between the disk spring 44 and either pin 52 or 54, thus the pins act as switch elements.

Referring to FIG. 5, the preferred embodiment is further illustrated in perspective view. The reference rod 38 extends through the hollow core 32 in the stud 30. The cap 50 is mounted to the head 34 of the stud 30 and holds the contact pins 52, 54 in proximity to the disk spring 44. It will be understood that although in this embodiment two contact pins are illustrated, other embodiments may include one or more contact pins.

The position of the pins 52, 54 within the cap 50 relative to the disk spring 44 may be calibrated to correspond to specific loads on the stud as follows: The cap 50 is mounted in the larger cavity 46 of the stud 30. A load is applied to the stud 30 that approximates a minimum recommended load, below which a warning situation would exist, for example a load of 50,000 lbs. A first pin 54 is then placed into a transverse hole in the cap 50 so that the end of the pin 54 abuts the disk spring 44. The pin 54 is fixed to the cap 50 using, for example, a wicking glue, such as cyanoacrylate. Subsequently, a load is applied to the stud 30, which approximates a minimum acceptable load below which the load is at a “danger” level of load, for example, a load of 30,000 lbs. A second pin 52 is then placed into a second transverse hole in the cap 50 so the end of the pin 52 abuts the disk spring 44. The pin 52 is fixed to the cap 50 using, for example, a wicking glue. In this manner, the pins 54, 52 may be calibrated to contact the disk spring 44 at loads below 50,000 lbs and 30,000 lbs respectively.

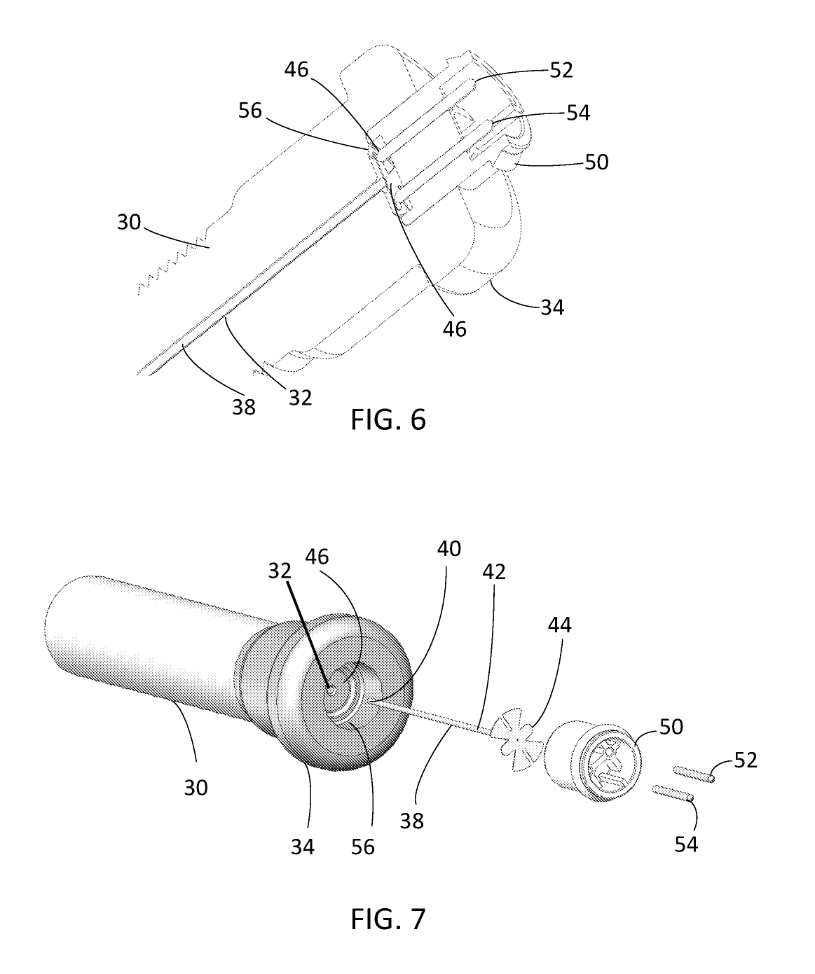

Referring now to FIGS. 6-7, a second embodiment of the load monitoring system is illustrated. In this embodiment, the larger cavity 46 is concave-shaped 56. Further, the disk spring 44 is flower-shaped or some other design to reduce the spring constant, rather than a solid disk shape. The concave shaped cavity 56 and flower-shaped disk spring 44 provide for sensing an overstressed stud, as described in detail below.

Referring again to FIG. 7, the load monitoring system according to the second embodiment may be calibrated to detect a possibly overstressed stud as follows: The disk spring 44 is attached to the free end 42 of the rod 38, for example by adhesive. A load, for example, of 75,000 lbs is applied to the stud 30, and the rod 38 and disk spring 44 assembly is inserted into the hollow core 32 of the stud 30 until the disk spring 44 abuts the concave-shaped base 56 of the larger cavity 46. The pins 52, 54 may then be positioned in the cap 50 relative to the disk spring 44 to correspond to specific loads on the stud, as described supra for the preferred embodiment.

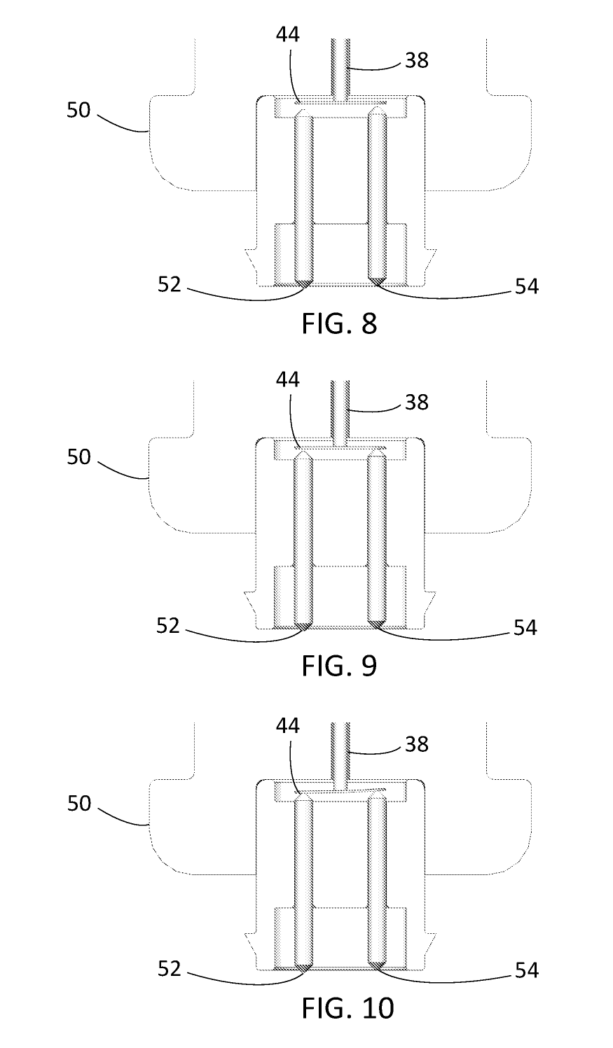

Referring now to FIGS. 8-10, the operation of the load monitoring system according to the first preferred embodiment will be explained. The conditions illustrated in FIGS. 8-10 also have been exaggerated for clarity. As illustrated in FIG. 8, it will be appreciated that in operation the wheel stud 30 will be tightened to a load of at least 50,000 lbs thus resulting in tension of the wheel stud and elongation relative to the reference rod 38. The elongation of the stud 30 relative to the reference rod 38 places the pins 52, 54 out of contact with the disk spring 44. As further illustrated in FIG. 9, in the circumstance that the load of the stud 30 decreases, for example by a loosening of the lug nut (not shown) to below 50,000 lb, then the pin 54 will be in electrical contact with the surface of the disk spring 44. As illustrated in FIG. 10, if the load of the stud 30 is further decreased below 30,000 lb, then the pin 52 is also in electrical contact with the surface of the disk spring 44.

For example, for a ⅞^{th} inch stud and if the length of the reference rod 38 is 2.2 inches long, then if 30,000 lbs force is applied to the stud 30, the deflection of the free end of rod 42 relative to the head of the stud 34 is about 0.0045 inches. The deflection at a maximum recommended preload of 62,000 lbs force is about 0.009 inches and 50,000 lbs force has a deflection of about 0.0075 inches.

A further operation of the load monitoring system according to the second preferred embodiment is provided when a load of over 75,000 lbs is applied to the wheel stud 30. This draws the free end of rod 42 into the hollow core 32, resulting in detachment of the disk spring 44 from the reference rod 38. Because of the concave shape 56 of the larger cavity 46, the released disk spring 44 makes contact with both pins 52, 54. In this case, the situation cannot be remedied by tightening of the lug nut and the vehicle operator can determine that the stud has been overtightened and possibly the stud has been overstressed and should be discarded.

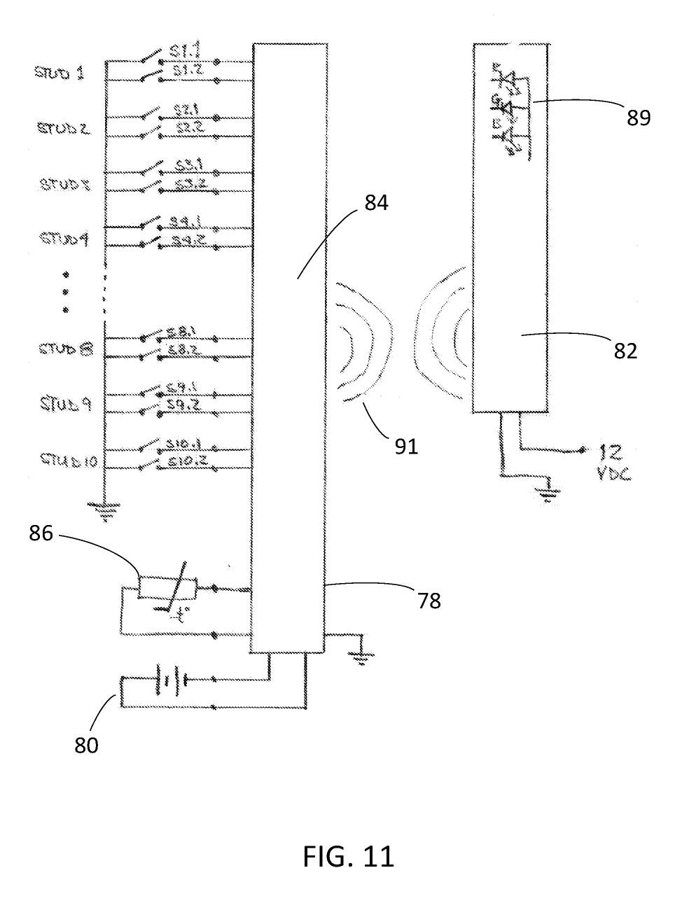

Referring to FIG. 11, for each stud on a wheel hub, designated STUD 1 to STUD 10, a wire leads from each contact pin 52, 54 to a PC board 78. Thus, there may be two wires per stud 30, 10 studs per wheel hub and one PC board 78 per wheel hub. The PC board 78 is mounted to the wheel hub. Contact between the pins 52, 54 and the disk spring 44, closes a switch, represented as S1.1 to S10.2, and sends an electrical signal to the PC board 78, mounted in the wheel hub The PC board 78 is capable of determining which pin 52, 54 is at issue in case of a closed switch. All three conditions illustrated in FIG. 8-10 can be interpreted by the PC board 78. All three conditions can be transmitted to the vehicle's warning system to inform the vehicle's operator of a lost nut, a broken stud or an over-tightened stud. To transmit a signal, the PC board 78 may communicate by RF 91 with a signal light or beacon 82, for example having a tri-colour LED light 89, mounted within view of the vehicle operator, for example on the side of a truck trailer. The condition of contact between pin 52 and disk spring 44 could be communicated to the beacon 82 resulting in a yellow light, providing a warning signal to the vehicle operator. The further condition of contact between pin 54 and disk spring 44 could be communicated to the beacon 82 resulting in a red light and thereby communicating to the vehicle operator that a hazardous situation exists and the vehicle should be pulled over. The beacon 82 can display a green light when both pins 52, 54 are open, i.e. not in contact with the flexible disk spring, indicating the load monitoring system is operating correctly, for example that the wheel hub transmitters are all communicating with the beacon, all pins are open and the temperature of the bearings are fine. If any faulty condition is detected, the beacon 82 will flash the appropriate colour in a code of short and long flashes, that identifies which wheel hub and stud is at fault. For example, yellow flashes of three long flashes followed by two short flashes repeatedly represents a warning that hub number three and stud number two is below the recommended tension. The beacon 82 communication to the vehicle operator occurs while the vehicle is in motion, so the vehicle does not have to be stopped to inspect the wheel stud condition. The condition of contact between pins 52 and 54 that cannot be remedied by tightening of a lug nut on the stud 30 would indicate that the disk spring 44 has detached because the stud 30 has been overtightened and possibly the stud has been overstressed.

The PC board 78 is preferably powered by a battery 80. The PC board 78 is grounded through an attachment to the wheel hub, for example by a bracket or with a ring connector under the head of one of the studs connected by wire to the PC board (not shown). The PC board 78 also has a transmitter 84 to transmit, by radio signal or otherwise, the conditions of the pins 52, 54 as interpreted by the PC board 78 to the beacon 82.

The PC board 78 may also be connected to a thermistor 86. The thermistor 86 is mounted to the wheel hub in proximity of the wheel bearings, in order to detect temperature changes due to bearing failure, in advance of failure. The PC board 78 monitors the resistance of the thermistor 86 to interpret the temperature of the hub near the bearings. If the PC board 78 interprets the temperature of the hub near the bearings to exceed a predetermined maximum acceptable value, the PC board transmits a signal to the beacon 82 to alert the vehicle operator that a hazardous condition exists due to bearing failure and overheating.

While two embodiments of the wheel stud load monitoring system have been illustrated in the accompanying drawings and described herein above, it will be appreciated by those skilled in the art that various modifications, alternate constructions and equivalents may be employed. It should be further understood that the claims are not intended to be limited to the particular forms disclosed, but rather to cover all modifications, equivalents, and alternatives falling within the spirit and scope of this disclosure.

Therefore, the above description and illustrations should not be construed as limiting the scope of the invention, which is defined in the appended claims.

1-6. (canceled)

7. A threaded fastener load monitoring system comprising:
a threaded fastener comprising a head end, a far end and a hollow core between said head end and said far end;
a reference rod mounted in said hollow core, said reference rod comprising an anchor end attached to said far end and a free end extending to said head end;
a flexible contact element mounted to said free end of said reference rod, said flexible contact element being movable to said head end upon elongation and relaxation of said threaded fastener;
first and second switch elements mounted to said head end of said threaded fastener at a proximity of said flexible contact element, said first switch element being positioned to make contact with said flexible contact element when said flexible contact element is in a first position and said first and second switch elements being positioned to make contact with said flexible contact element when said flexible contact element is in a second position; and
an electronic circuit interpreting conditions of said first and second switch elements.

8. The threaded fastener load monitoring system of claim 7, wherein said electronic circuit is mounted in a wheel hub and comprises a transmitter circuit mounted therein.

9. The threaded fastener load monitoring system of claim 7, wherein said first position is equivalent to an elongation of said threaded fastener to an undesired tension and said second position is equivalent to an elongation of said threaded fastener to a dangerous tension.

10. The threaded fastener load monitoring system of claim 7, wherein said flexible contact element is made of gold-plated metal.

11. The threaded fastener load monitoring system of claim 10, wherein said switch elements are made of gold-plated metal.

12. The threaded fastener load monitoring system of claim 8, further comprising a battery-operated radio-frequency transmitter circuit mounted to said wheel hub.

13. The threaded fastener load monitoring system of claim 7, further comprising a thermistor mounted to a wheel hub in proximity to wheel bearings and connected to the electronic circuit, for sensing temperature changes to said wheel bearings.

14. A road vehicle having a wheel rotor assembly comprising a wheel rotor, a wheel stud mounted to said wheel rotor and a wheel stud load monitoring system mounted to said wheel stud, said wheel stud load monitoring system comprising:
a stud comprising a head end, a far end and a hollow core;
a reference rod mounted in said hollow core;
said reference rod comprising an anchor end held to said far end, a free end extending to said head end;
a flexible contact element mounted’ to said free end of said reference rod;
said flexible contact element being movable in said head end along a displacement path extending between a first position and a second position, upon elongation and relaxation of said wheel-stud;
at least one switch element mounted in said head end at a proximity of said flexible contact element and along said displacement path of said flexible contact element;
said switch element making calibrated contact with said flexible contact element upon a movement of said flexible contact element along said displacement path; and
an electronic circuit mounted in said wheel hub interpreting conditions of said switch element.

15. The road vehicle of claim 14, wherein said electronic circuit comprises a signal transmitter transmitting conditions of said switch elements to a remote receiver.

16. The road vehicle of claim 15, wherein said electronic circuit includes a battery and said electronic circuit is operated by said battery.

17. The road vehicle of claim 14, wherein a distance between said first and second position of said ground switch elements is a same distance as an elongation of said stud in a desired tension of said stud and a dangerous position of said stud.

18. The road vehicle of claim 14, further comprising a third position, wherein said flexible contact element makes permanent contact with said switch elements and wherein said third position corresponds to an elongation of said stud in a dangerous range of elongation for said stud.

19. The road vehicle of claim 15, wherein said remote receiver comprises a signaling device that is visible to a road vehicle operator while the road vehicle is in operation.

20. A method for assembling a load monitoring system comprising:
inserting a rod with an attached flexible contact element in a hollow core of a threaded fastener, said threaded fastener having a head, a far end, a hollow core extending from said far end to said head and a larger cavity in said head;
applying a first tension to said threaded fastener;
mounting a cap on said head of threaded fastener;
placing a first switch element through a first transverse hole in said cap so that said first switch element abuts said flexible contact element;
fixing said first switch element to said cap with an adhesive;
applying a second tension to said threaded fastener;
placing a second switch element through a second transverse hole in said cap so that said second switch element abuts said flexible contact element; and
fixing said second switch element to said cap with said adhesive.

21. The method of claim 20, wherein the adhesive is a low viscosity glue.

22. The method of claim 20, wherein said second tension is less than said first tension.

23. The method of claim 20, wherein inserting a rod with an attached flexible contact element in said hollow core comprises:
applying third tension to said threaded fastener, said third tension being greater than said first and second tension;
inserting said rod until said flexible contact element abuts the surface of said larger cavity.

24. The method of claim 23, wherein the third tension corresponds to a tension that may overstress said threaded fastener.
